(19) United States
(12) Patent Application Publication
(10) Pub. No.: US 2010/0014094 A1
(43) Pub. Date: Jan. 21, 2010

(54) DISTRIBUTED GAS DETECTION

(76) Inventors: Barrett E. Cole, Bloomington, MN (US); James A. Cox, New Brighton, MN (US); Teresa M. Marta, White Bear Lake, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/177,053

(22) Filed: Jul. 21, 2008

(51) Int. Cl. G01N 21/00; G01B 9/02

(52) U.S. Cl. 356/480; 356/437; 356/519

(57) ABSTRACT

A system includes a plurality of optical resonators, a light source, an optical fiber that couples the plurality of optical resonators to the light source, and a detector that is coupled to the plurality of optical resonators. The detector is configured to detect an energy in the plurality of optical resonators.

### RELATED APPLICATION

This application is related to U.S. application Ser. No. 11/384,017, which was filed on Mar. 17, 2006 and published as US20070216903 on Sep. 20, 2007.

### TECHNICAL FIELD

Various embodiments relate to the detection of gases, particles, and compounds, and in an embodiment, but not by way of limitation, distributed gas detection.

### BACKGROUND

It is desirable to have sensors located at positions where the events to be sensed are occurring. While this is generally true no matter the event, substance, or compound that is to be sensed, it is particularly true for gas sensors. For the detection of gases at multiple locations, the standard approach is aspiration, wherein the gas is taken from a remote location to a sensitive sensor at a fixed location that can provide the necessary sensitivity for adequate detection. However, this standard approach has some drawbacks in that many things can happen to the gas on the way to the sensing element.

### BRIEF DESCRIPTION OF THE DRAWINGS

FIG. 1 is an example embodiment of a cavity ring down spectrometer.

FIG. 2 is a graph illustrating cavity ring down.

FIG. 3 is an example embodiment of a system of a tunable laser or other light source coupled to a plurality of optical resonators.

FIG. 4 illustrates an example absorption spectra of ammonia (NH₃) showing high and low absorption lines and wavelengths of possible laser tuning.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, an apparatus is provided for measuring a gas within a semiconductor thin film process. The apparatus includes an optical resonator disposed within an environment of the thin-film process, a light source that is launched into the optical resonator at a characteristic frequency of the gas, a detector that detects an energy escaping from the resonator and a processor that calculates a concentration of the gas based upon a ring down rate of the detected energy. The light source can be an ordinary light source, a laser, a tunable laser, or a combination of any of the foregoing.

In an embodiment, an apparatus includes a light source such as a laser, a modulator, and other high end components that are necessary for precision high sensitivity measurements. The light from these components is distributed to a plurality of remote units that includes the lower cost components of the system. In this way, the distributed system avoids having a number of high end components distributed around the gas sensing locations. The location of the sensing head where the gas is to be sensed contributes to reducing gas handling costs and reduces performance disadvantages. It makes it possible to sense toxic or corrosive gases without the need for piping these gases to a central location with pipes that have to be designed to handle a wide range of corrosive gases. To accomplish this, fiber optical elements communicate a probe light to the remote spot where the sensor and gas are located. In an embodiment, the light is directed to remote resonators located in room air that sample the concentration of gas species in that environment.

In an embodiment, the distributed system includes a central optical processing module. The light is distributed either sequentially through optical switches or other means to the units, or it is split and distributed simultaneously to all units. An optical measurement, which can include absorption, fluorescence, time decay, or scattering for example, can be taken by a dedicated detector at the site, and the results interpreted and sent back as a simple value to a main control unit. In another embodiment, the optical signal can be sent back to a home base for analysis. The method that is chosen is influenced by the expense of the unit required to make the analysis. In an example of cavity ring down spectroscopy, the light source and modulator are maintained at the control center. Optical fibers feed the light to the remote cavity ring down spectroscopy sensing module. At the module, a piezoelectric mirror is continually run through the optical modes and the light is coupled into the cavity. The light to the central modulator is shut off, and the decay time is measured by the remote detectors and an application specific integrated circuit analyzer. The light source at central control is then tuned to another wavelength and the process is repeated. This method or similar methods in which light is the probe can be delivered to the remote probes much as wires would be used to deliver electrical signals for remote sensing and analysis. The remote nature of this makes it possible to sense at the remote environment with much higher signal integrity. Multiple sources with different emission wavelengths can be located at the central station, and can send different wavelengths to the same remotely distributed rings to permit analysis of different gases that have absorption in different spectral regions.

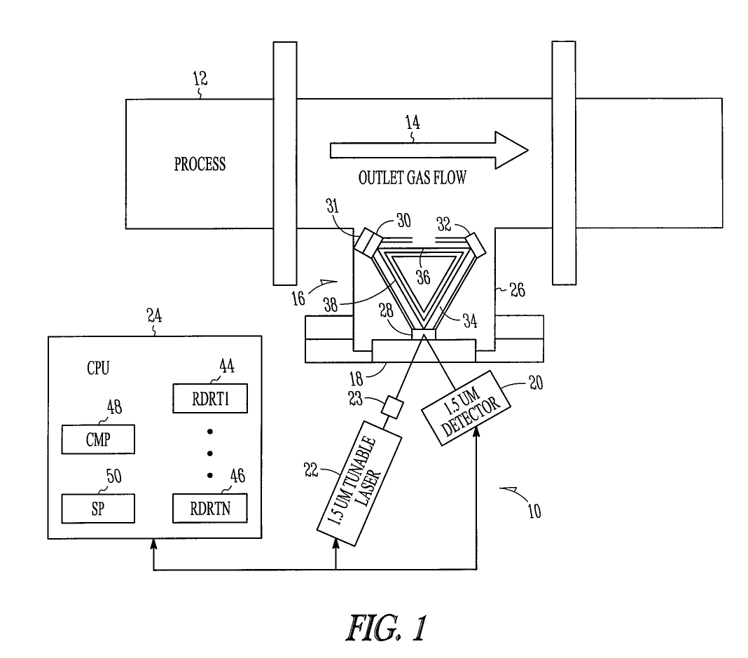

FIG. 1 is a block diagram of a gas detection system 10, shown in a context of use generally in accordance with an illustrated embodiment of the invention. As shown in FIG. 1, the detection system 10 may be used to monitor gas concentrations within a semiconductor thin film process 12. While the system 10 is shown as being used to detect gas concentration in an outlet gas flow (stream) 14, it should be understood that the system 10 could just as well be used to detect an inlet gas flow into the process 12.

The detection system 10 may include an optical resonator 16, an optical detector 20, a tunable laser or other light source 22, and a central processing unit (CPU) 24. When a tunable laser is used, the tunable laser may be tunable over some appropriate optical wavelength range (e.g., 1-12 micrometers).

The optical resonator 16 may be placed directly in the outlet gas flow 14 or offset from the gas stream within a “T” connection 26 as shown in FIG. 1. As would be known to those of skill in the art, the input and output gas flows of the process 12 may include a number of very corrosive gases. Since the optical resonator 16 is located in the gas stream, the optical resonator 16 may be fabricated of materials that are resistant to those gases. With suitable protective provision, the tunable laser 22 and detector 20 may also be located within the gas stream 14 or may interact with the resonator 16 through an optically transparent window 18 that functions to isolate the process environment from the instrument environment.

The window 18 may be fabricated of an appropriate optical glass (e.g., quartz glass). Alternatively, the window 18 may be fabricated from sapphire.

The optical resonator 16 may consist of three mirrors 28, 30, 32 in the form of a triangle. The tunable laser 22 may be aligned coaxially with a first leg 34 of the triangle. Optical energy entering the resonator 16 through the first mirror 28 propagates along the first leg 34 of the resonator 16 and is reflected by a second mirror 32. Reflected energy from the second mirror 32 propagates along a second leg 36 to the third mirror 30 and is reflected along a third leg 38 to the first mirror 28. The sum total of the lengths of the legs 34, 36, 38 may be an integral multiple of the resonant frequency.

At the first mirror 28 most of the optical energy is reflected along the first leg 34 and recirculates around the triangle. However, at least some of the energy propagating along the third leg 38 passes through the first mirror 28 and impinges on the detector 20 coaxially aligned with the third leg 38.

In general, the gas detection system 10 functions in accordance with the principles of spectroscopy. As is known, each gas in the gas stream 14 absorbs optical energy at wavelengths that are characteristic for the gas. By tuning the tunable laser 22 to a characteristic frequency of a predetermined gas, or providing another light source at the characteristic frequency, the system 10 can measure the concentration of the predetermined gas independently of the presence or concentrations of other gases within the gas stream 14. As is known, the greater the concentration of the predetermined gas, the greater the absorption of the characteristic wavelength of optical energy.

In order to measure gas concentrations, the tunable laser 22 may be tuned to a characteristic wavelength of the gas. A simple mechanical servo 31 may be used to adjust the sum length of the three legs 34, 36, 38 to an integral multiple of the selected wavelength.

The tunable laser 22 may be pulsed at some predetermined rate (e.g., 50 pulses per second) to deliver optical pulses of an appropriate duration (e.g., a few nanoseconds) to the resonator 16. Pulsing may be accomplished through use of a shuttering device (e.g., an acousto-optic modulator).

The application of the pulses to the resonator 16 causes the optical energy to recirculate around the resonator 16 (i.e., the resonant structure or “rings” of the resonator 16). The decay rate (i.e., the “ring down rate”) of the optical energy within the resonator 16 depends upon the wavelength of the optical energy, the gas within the stream 14, and the optical losses of the resonator 16.

FIG. 2 is an example of an amplitude versus time graph that shows ring down rates of the resonator 16 in the case of a predetermined gas and the resonator 16 resonating at the characteristic wavelength of the predetermined gas. As shown, the resonator 16 would have a first characteristic curve 40 in a vacuum and a second characteristic curve 42 in the presence of some maximum concentration of the predetermined gas. Any concentration of the predetermined gas below the maximum concentration would have its characteristic curve somewhere between curves 40 and 42. The group of curves of FIG. 2 represents a ring down rate profile for a gas.

In an embodiment, the ring down rate (or ring down time) can be calculated using the following equation:

$$\frac{1}{{τ}_{λ}} = c ( \frac{1 - {R}_{λ}}{L} + {ρ}_{λ} {σ}_{λ} ) ;$$

The variable τ_{λ} represents the cavity ring down time at a wavelength λ. The term c is the speed of light. R_{λ} is a total or cumulative reflectance of all the mirrors in a particular resonance or ring structure. L is a length of the optical path within the resonance structure, that is, the total distance around the resonance or ring structure. The term ρ_{λ} is the concentration of a gas within the optical path at the wavelength λ, and the term σ_{λ} is the absorption cross section of a gas at the wavelength λ.

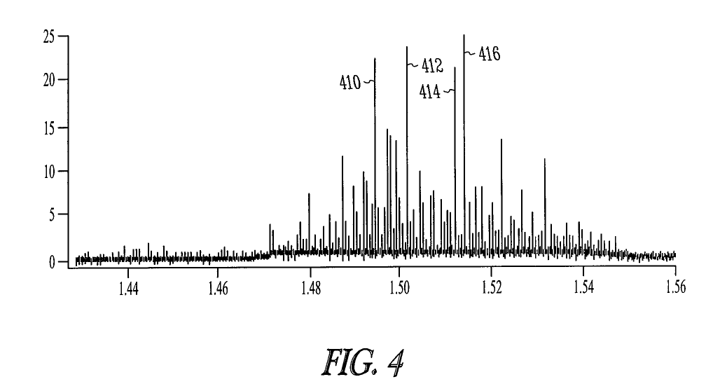

The concentration of a gas can be determined in real-time in any particular resonator 16 in the system 300. A source of light is pulsed into the system 300 and into one or more optical resonators 16 at a resonant wavelength of the particular gas that is to be detected. As noted above, in an embodiment, the pulse frequency is about 50 pulses per second. If the gas is not present, a ring down time results that indicates the absence of the gas. If the gas is present, a ring down time results that indicates the presence of the gas, and the concentration of that gas ρ_{λ} can be calculated using the above-noted equation. For any particular gas, several different resonant wavelengths are used so that any two compounds that share a single particular resonant wavelength can then be distinguished by the one or more wavelengths that the two compounds do not share. For example, the resonant wavelengths 410, 412, 414, and 416 for ammonia as indicated in FIG. 4 could all be used so as to distinguish ammonia from a compound that has resonant wavelengths the same as or very close to wavelengths 412 and 414, but has no similar wavelengths to 410 and 416.

To measure a gas concentration, the CPU 24 may sequentially select each gas of the set and measure a concentration as described above based upon a characteristic wavelength of the selected gas. Where the system 10 is used for process control, the measured values may be transferred to a process controller (not shown) as feedback control for the process.

In general, the system 10 may be used to monitor gas constituents of the stream 14 from the parts per million (ppm) to the parts per trillion (ppt) range by measuring gas absorption via changes in the ring down time for unique gas absorption wavelengths and then converting this to concentration using known absorption cross sections.

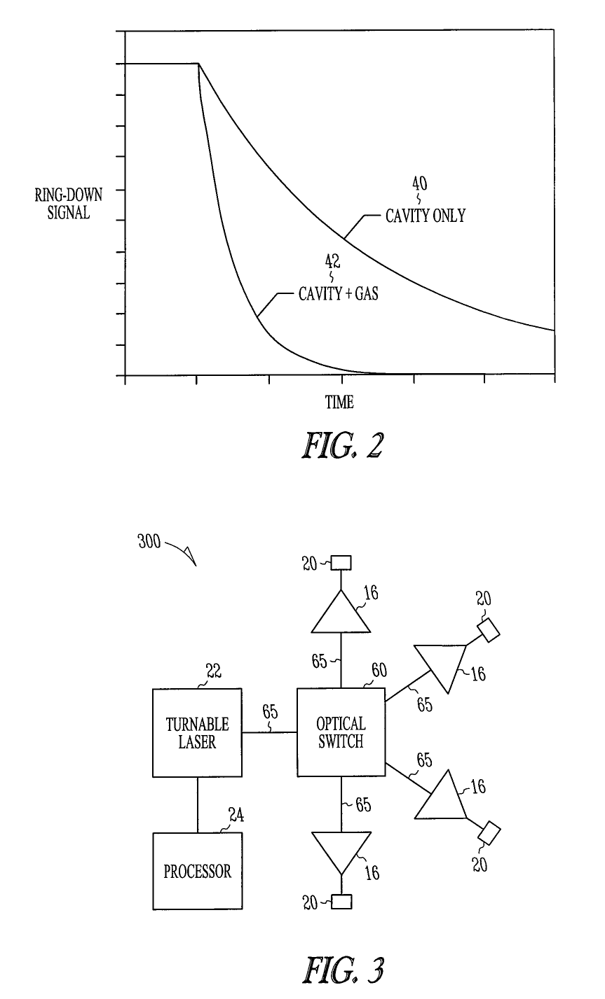

FIG. 3 illustrates an example embodiment of a system 300 of a plurality of optical resonators 16 coupled to a tunable laser 22 (or other light source) via optical fiber 65 and an optical switch or other switching/distribution means 60. As explained above, the tunable laser 22 can be tuned to a particular wavelength or wavelength range, and emit a laser beam at that wavelength or wavelength range. The optical switch 60 can distribute the beam to the plurality of optical resonators 60 in a serial fashion or other distribution method or pattern. In another embodiment, there is no optical switch 60, and the laser beam is simply equally distributed to the plurality of optical resonators 16. The processor 24 can control the emission of the laser beam from the tunable laser 22, and the processor 24 can also be used to receive data from the detector 20 to calculate the ring down time for each individual optical resonator 16.

In an embodiment, various optical resonators 16 in the system 300 are different sizes and include therein different peak wavelengths. Any particular wavelength can be set in any particular resonator 16 by appropriately tuning a laser or selecting a particular light source. In this manner, a range of gases can be detected at different sensitivity levels.

FIG. 4 is an example spectrograph 400 illustrating the absorbance of gaseous ammonia (NH₃) at several wavelengths (measured in micrometers). The spectrograph 400 includes the wavelength measured in micrometers along the x-axis, and the absorbance along the y-axis. As an example, the spectrograph 400 illustrates that ammonia absorbs the most optical energy at wavelengths of approximately 1.49, 1.50, and 1.51 micrometers as indicated by peaks 410, 412, 414, and 416 in FIG. 4. Such a spectrograph as illustrated in FIG. 4 can then be compared to the transmittance values at an optical resonator, and a determination can be made as to whether a particular gas (in this example ammonia) is present.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A system comprising:
a plurality of optical resonators with detectors;
a light source; and
optical fibers coupling the plurality of optical resonators to the light source.

2. The system of claim 1, wherein the light source comprises a laser.

3. The system of claim 2, wherein the laser is tunable to a plurality of wavelength ranges.

4. The system of claim 1, comprising a means of redirecting the light source.

5. The system of claim 1, comprising an optical switch to redirect the light source, the optical switch coupling the light source to the plurality of optical resonators.

6. The system of claim 1, wherein each of the plurality of optical resonators comprises:
a section to receive energy from the light source; and
a resonant structure forming a closed circuit path.

7. The system of claim 6, wherein the resonant structure comprises a ring structure.

8. The system of claim 7, wherein the ring structure comprises a polygon.

9. The system of claim 1, comprising a processor coupled to the plurality of optical resonators, the processor configured to detect the presence of one or more gases using data from the plurality of optical resonators.

10. The system of claim 9, wherein the processor is further configured to obtain the concentration of gases detected using the data obtained from the plurality of optical resonators.

11. The system of claim 9, wherein the data from the plurality of optical resonators comprises a ring down time for the plurality of optical resonators.

12. The system of claim 11, wherein the ring down time is calculated as follows:
$$\frac{1}{{τ}_{λ}} = c ( \frac{1 - {R}_{λ}}{L} + {ρσ}_{λ} ) ;$$
wherein τ_{λ} is the cavity ring down time at a wavelength λ;
c is the speed of light;
R_{λ} is a total reflectance of mirrors in the system at the wavelength λ;
L is a length of an optical path of the resonator under measurement;
ρ is the concentration of a gas within the optical path; and
σ_{λ} is the absorption cross section of a gas at the wavelength λ.

13. The system of claim 9, wherein the processor is configured to calculate the ring down time at each wavelength of the tunable laser by:
receiving a plurality of transmitted intensity signals from the detector;
computing a ring-down decay time from the transmitted intensity signals;
converting the ring-down decay time into an absorption coefficient at the particular wavelength;
determining the presence of a particular species by comparing the absorption coefficient at the particular wavelength with known tabulated values of absorption spectra; and
determining the concentration of the particular species by dividing the measured absorption coefficient by the tabulated absorption cross-section of the species at the particular wavelength.

14. The system of claim 13, wherein the substance comprises a gas.

15. The system of claim 1, wherein the system is configured to detect one or more of a gas, ground water, an air particulate, and a chemical.

16. The system of claim 1, wherein a detector is associated with each optical resonator.

17. The system of claim 1, comprising a plurality of light sources.

18. The system of claim 1, wherein the plurality of optical resonators comprise various sizes and comprise various peak wavelengths.

19. A system comprising:
a plurality of optical resonators with detectors;
a tunable laser; and
an optical fiber coupling the plurality of optical resonators to the tunable laser.

20. A system comprising:
a plurality of optical resonators with detectors;
a light source;
an optical switch; and
an optical fiber coupling the plurality of optical resonators, the light source, and the optical switch.
